(19) United States
(12) Patent Application Publication
(10) Pub. No.: US 2012/0258543 A1
(43) Pub. Date: Oct. 11, 2012

(54) BIOGENIC SUBSTANCE MEASURING METHOD

(75) Inventors: Yasuo KIKKAWA, Kakogawa-shi (JP); Toshihiro WATANABE, Akashi-shi (JP)

(73) Assignee: SYSMEX CORPORATION, Kobe-shi (JP)

(21) Appl. No.: 13/443,383

(22) Filed: Apr. 10, 2012

(30) Foreign Application Priority Data
Apr. 11, 2011 (JP) 2011-086996

(51) Int. Cl. G01N 21/64

(52) U.S. Cl. 436/74

(57) ABSTRACT

To provide a method configured to effectively control in a simplifier manner any adverse influences from perspiration excreted from a skin currently measured when a biogenic substance from tissue fluid extracted through fine pores is measured, the method includes steps of: forming a film having a water impermeability on the test subject's skin; forming fine pores in the skin coated with the film so as to penetrate through the film; extracting the tissue fluid from the test subject through the skin where the fine pores are formed; storing the constituent to be measured and inorganic ions of the extracted tissue fluid; obtaining an ion information relating to a quantity of the stored inorganic ions and a constituent information relating to a quantity of the stored constituent; and obtaining an analysis value relating to the quantity of the constituent based on the ion information and the constituent information.

### FIELD OF THE INVENTION

The present invention relates to a biogenic substance measuring method, more particularly to a method for measuring a constituent of tissue fluid extracted from a test subject's skin to be measured after the skin is subjected to a treatment for accelerating the extraction of tissue fluid.

### BACKGROUND

### Related Art

According to a disclosed method, tissue fluid is extracted through fine pores formed in a test subject's skin using a puncturing tool to analyze inorganic ions (sodium ions, potassium ions, or chloride ions) as well as a constituent of the tissue fluid to be measured, and the constituent of the tissue fluid is measured after a quantity of tissue fluid to be extracted is corrected based on a measured value (concentration) of the inorganic ions (for example, see U.S. Patent Publication No. 2010/160758). According to the method disclosed in U.S. Patent Publication No. 2010/160758, a tissue fluid collecting sheet including a collecting member made of gel is attached to the skin of a test subject for a predetermined period of time to collect the tissue secreted through the skin in the gel.

While the method disclosed in U.S. Patent Publication No. 2010/160758 is based on the premise that no test subjects undergo perspiration, some test subjects naturally excrete perspiration during the collection of tissue fluid. In the event of excessive perspiration, sodium ions, potassium ions, or chloride ions included in perspiration from any part of the skin with no fine pores may infiltrate the collecting member, resulting in the failure to accurately measure the quantity of tissue fluid to be extracted.

According to the methods for percutaneously sampling any analysis targets disclosed in U.S. Patent Publication No. 2005/069925 and U.S. Patent Publication No. 2006/127964, in order to control adverse influence of perspiration from the skin, a component analysis is performed in a part of skin where fine pores are formed and another part of skin with no such fine pores, and any adverse influences induced by perspiration are corrected based on information obtained from these two parts of the skin.

However, it is known that the perspiration through skin differs depending on which part of the skin the perspiration is excreted from. Besides, different quantities of perspiration may be excreted from the part where the fine pores are formed and any other parts with no such fine pores. In view of these facts, there is undeniably a certain limit on the accuracy of correction according to the methods disclosed in U.S. Patent Publication No. 2005/069925 and U.S. Patent Publication No. 2006/127964. According to these methods, it is necessary in one measuring operation to obtain two sites to be measured and perform a component analysis for two testing materials (collecting members).

### SUMMARY OF THE INVENTION

The scope of the present invention is defined solely by the appended claims, and is not affected to any degree by the statements within this summary.

The present invention was accomplished under the circumstances described so far. The present invention provides a biogenic substance measuring method wherein any adverse influences from perspiration through skin during a biogenic substance measuring operation can be effectively controlled in a simplified manner when tissue fluid is extracted through fine pores to measure biogenic substance.

A first aspect of the present invention is a biogenic substance measuring method for measuring a constituent of tissue fluid extracted from a test subject's skin, comprising steps of:

forming a film having a water impermeability on the test subject's skin;

forming fine pores in the skin coated with the film so as to penetrate through the film;

extracting the tissue fluid from the test subject through the skin where, the fine pores are formed and storing the constituent to be measured and inorganic ions of the extracted tissue fluid;

obtaining an ion information relating to a quantity of the stored inorganic ions;

obtaining a constituent information relating to a quantity of the stored constituent to be measured; and

obtaining an analysis value relating to the quantity of constituent to be measured based on the ion information and the constituent information.

According to the biogenic substance measuring method provided by the present invention, any adverse influences from perspiration through skin during a biogenic substance measuring operation can be effectively controlled in a simplified manner when tissue fluid is extracted through fine pores to measure biogenic substance.

### BRIEF DESCRIPTION OF THE DRAWINGS

FIG. 1 is a perspective illustration of an external appearance of a biogenic substance measuring device used in a biogenic substance measuring method according to the present invention.

FIG. 2 is a block diagram of the biogenic substance measuring device illustrated in FIG. 1.

FIG. 3 is a sectional view schematically illustrating a cartridge structure.

FIG. 4 is a perspective illustration of a fine pore forming device configured to form fine pores in a test subject's skin.

FIG. 5 is a perspective view of a fine needle chip loaded in the fine pore forming device illustrated in FIG. 4.

FIG. 6 is an illustration of the skin in cross section where fine pores are formed by the fine pore forming device.

FIG. 7 is a perspective illustration of a collecting member.

FIG. 8 is a sectional view cut along A-A line illustrated in FIG. 7.

FIG. 9 is a flow chart of a biogenic substance measuring method according to an embodiment of the present invention.

FIG. 10 is an illustration of an opening of a frame-shape seal attached to a test subject's skin and supplied with a film-forming resin.

FIG. 11 is a graphical illustration of a correlation between a glucose permeability and a sodium ion extraction rate.

FIG. 12 is a graphical illustration of a perspiration inhibiting effect exerted by a film.

### DETAILED DESCRIPTION OF THE PREFERRED EMBODIMENTS

The preferred embodiments of the present invention will be described hereinafter with reference to the drawings.

Hereinafter, preferred embodiments of a biogenic substance measuring method according to the present invention are described in detail referring to the accompanied drawings.

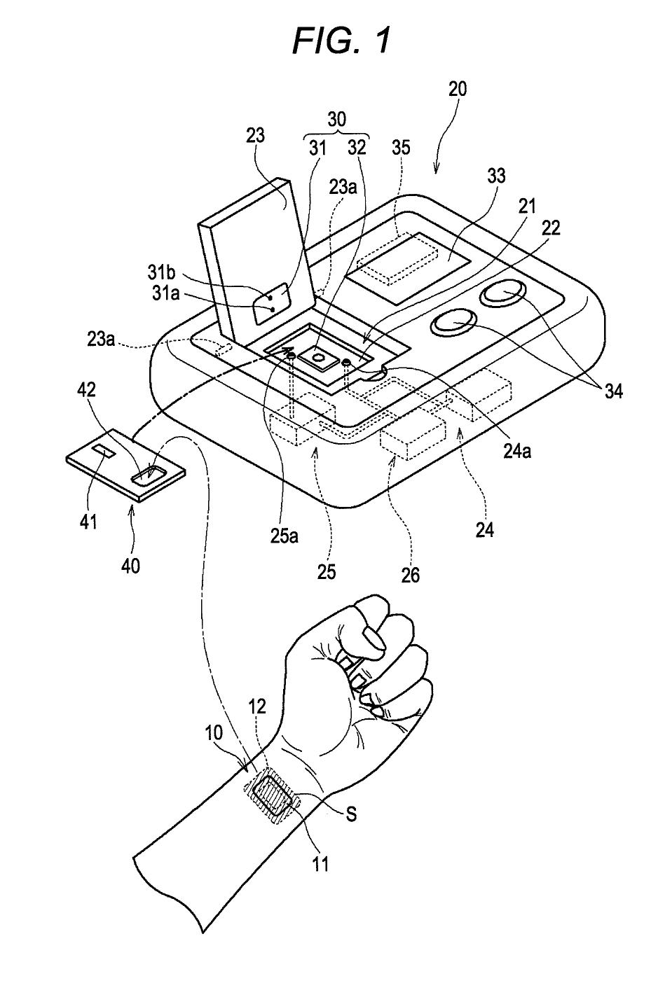

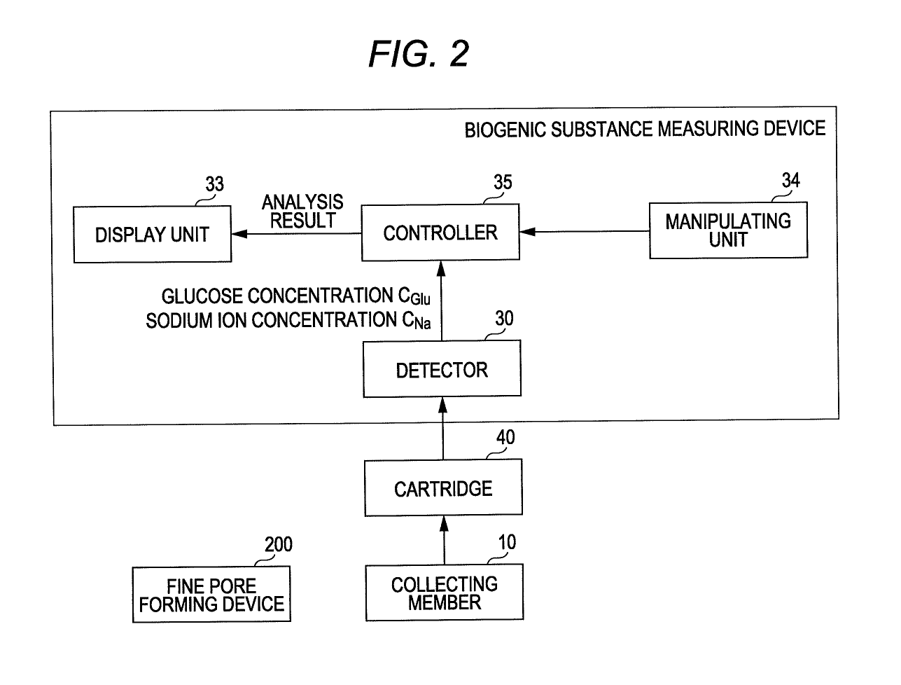

To start with, a general description is given to the biogenic substance measuring method referring to FIG. 1.

According to the biogenic substance measuring method provided by the present embodiment, which will be described in detail later, fine pores are formed in a test subject's skin through a film formed on the skin to extract tissue fluid through the fine pores so that glucose and sodium ions included in the extracted tissue fluid are collected, and blood glucose (blood glucose count) of the test subject is estimated based on concentrations of the collected glucose and sodium ions. More specifically, the method is used to calculate an area under the blood glucose-time curve (blood glucose AUC).

When a test subject is perspiring, glucose and sodium ions originated from the perspiration are collected such that the glucose and sodium ions are superimposed on glucose and sodium ions contained in tissue fluid. A quantity of glucose in perspiration, however, is very small that is almost ignorable as compared to a quantity of glucose in tissue fluid, causing no problems on an accuracy to be desirably obtained. The sodium ions from perspiration, on the other hand, amounts to a noticeable quantity depending on the extent of perspiration as compared to a quantity of sodium ions in tissue fluid, possibly resulting in a poor reliability of the calculated blood glucose AUC (estimated blood glucose AUC).

According to the present embodiment, a film-forming resin in liquid phase is applied to a test subject's skin where fine pores are formed before the fine pores are formed in the skin to accelerate the extraction of tissue fluid, and the applied film-forming resin is thereafter dried to form a film. The film is water-impermeable'. Therefore, the film can prevent perspiration from any other parts of the skin with no fine pores from infiltrating an extraction medium when the tissue fluid is extracted through the fine pores formed in the skin in the presence of the film therebetween. This prevents inorganic ions included in the perspiration from infiltrating the extraction medium, thereby achieving a higher reliability of the calculated blood glucose AUC (estimated blood glucose AUC).

### Biogenic Substance Measuring Device

A biogenic substance measuring device 20 is configured to measure glucose and sodium ions included in tissue fluid collected in an extraction medium 12 of a collecting member 10, which will be described later, to obtain a glucose concentration (C_{Glu}) and a sodium ion concentration (C_{Na}) and calculate blood glucose AUC of a test subject based on the obtained C_{Glu} and C_{Na}, and generate and display an analysis result including the calculated blood glucose AUC. The biogenic substance measuring device 20 includes a detector 30, a controller 35 including an analysis unit, a display unit 33 which displays thereon data such as an analysis result, and an operation button 34 as a manipulating unit for issuing instructions such as an instruction to start measurement.

The biogenic substance measuring device 20 has a thick cabinet formed in a parallelepipedal shape, and a recessed portion 21 is formed in a top plate on an upper surface of the cabinet. The recessed portion 21 is provided with a cartridge loading portion 22 dented in a further depth than the recessed portion 21. A movable top plate 23 having a thickness dimension almost equal to a side wall height of the recessed portion 21 is coupled with the recessed portion 21. When the movable top plate 23 is rotated around a support shaft 23a, the movable top plate 23 in a standing position illustrated in FIG. 1 can be housed in the recessed portion 21 or the movable top plate 23 housed in the recessed portion 21 can return to the standing position illustrated in FIG. 1. The cartridge loading portion 22 is dimensionally large enough to house therein a cartridge 40 described later.

The movable top plate 23 is supported by the support shaft 23a to be energized in a direction where the movable top plate 23 is housed in the recessed portion 21. Because of the movable top plate 23 thus structurally characterized, the cartridge 40 loaded in the cartridge loading portion 22 is pushed downward from an upper direction by the movable top plate 23.

The detector 30 is configured to obtain information of a constituent of tissue fluid collected in the extraction medium 12 of the collecting member 10. The detector 30 includes a glucose detector 31 configured to detect the glucose concentration C_{Glu}, and a sodium ion detector 32 configured to detect the sodium ion concentration C_{Na}.

The glucose detector 31 is provided on a rear surface of the movable top plate 23, which is a surface facing the cartridge loading portion 22 when the movable top plate 23 is housed in the recessed portion 21. The glucose detector 31 includes a light source 31a for light irradiation, and a photo detector 31b for receiving a reflected light from the light irradiation by the light source 31a. The glucose detector 31 thus structurally characterized can irradiate the light on the cartridge 40 loaded in the cartridge loading portion 22 and receive the reflected light from the light irradiation on the cartridge 40.

The sodium ion detector 32 is provided on a bottom surface of the cartridge loading portion 22. The sodium ion detector 32 has a plate-like member having a rectangular shape and provided on the bottom surface of the cartridge loading portion 22, wherein a pair of electrodes for measuring the sodium ion concentration is provided at a substantially central part of the plate-like member. The electrodes for measuring the sodium ion concentration include a sodium ion selective electrode having a sodium ion selective film and made of silver or silver Chloride, and another electrode paired with the electrode and made of silver or silver chloride.

The controller 35 is provided inside the biogenic substance measuring device 20. The controller 35 includes a CPU functioning as an analysis unit, and ROM and RAM used as storage unit. The CPU reads and runs programs stored in the ROM to control the operations of the respective structural elements of the device. The RAM is a working region for running the programs stored in the ROM.

The biogenic substance measuring device 20 includes a feeder 24 including a pump, a tank 26 which contains therein a collecting liquid containing purified water and used to collect the tissue fluid collected in the extraction medium 12 of the collecting member 10, and a waste liquid tank 25 used as a waste liquid storage. The feeder 24 blows air into the tank 26 to thereby inject the collecting liquid contained in the tank 26 into the cartridge 40 loaded in the cartridge loading portion 22 through a nipple 24a.

The waste liquid tank 25 is a container into which the purified water delivered into the cartridge 40 by the feeder 24 is discharged. The liquid is discharged through a nipple 25a to be stored in the waste liquid tank 25.

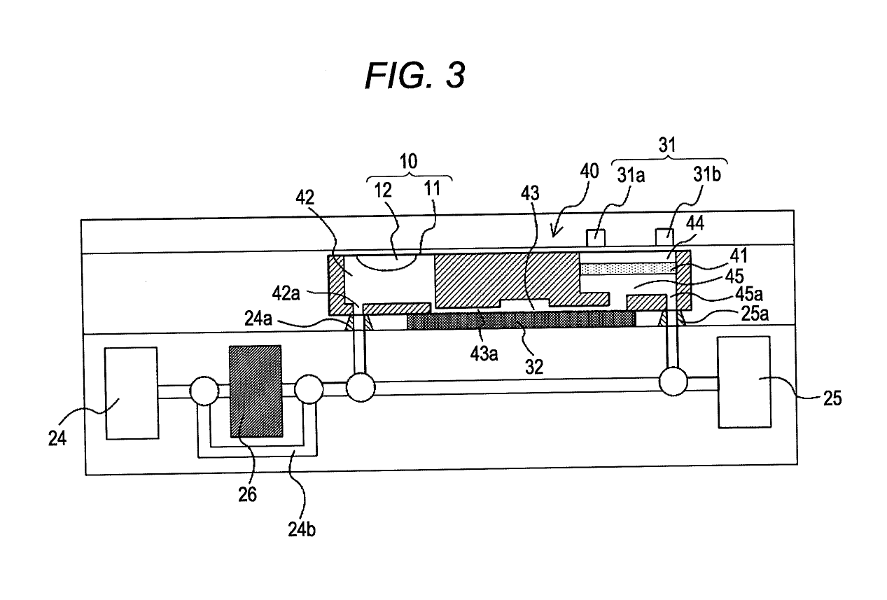

FIG. 3 is a sectional view schematically illustrating the cartridge loading portion 22 loaded with the cartridge 40. Referring to FIG. 3, structural characteristics of the cartridge 40 are described below.

The principal structural elements of the cartridge 40 are a gel container 42, a glucose reactor 41, and an optical waveguide member 44. The gel container 42 is formed by a recessed portion provided in a surface of the cartridge 40. A bottom section of the gel container 42 is provided with an injection hole 42a communicating with the nipple 24a provided in the cartridge loading portion 22. A groove communicating with the gel container 42 is formed in a lower surface of the cartridge 40. The groove and the sodium ion detector 32 provided in the bottom section of the cartridge loading portion 22 constitute a flow channel 43a. A part of the flow channel 43a is used as a first reservoir 43 where the sodium ion concentration is detected by the sodium ion detector 32. A downstream side of the flow channel 43a communicates with a second reservoir 45. The second reservoir 45 is formed by a recessed portion provided in the surface of the cartridge 40. An opening side of the recessed portion is blocked by the optical waveguide member 44 having an optical waveguide. A lower surface of the optical waveguide member 44 is provided with a glucose reactor 41 which changes in color when reacted with glucose. A bottom section of the second reservoir 45 is provided with a discharge hole 45a communicating with a nipple 25a provided in the cartridge loading portion 22.

The biogenic substance measuring device 20 measures the glucose concentration C_{Glu} and the sodium ion concentration C_{Na} in the tissue fluid collected in the collecting member 10 in the manner described below. Referring to FIG. 1, the collecting member 10 attached to a test subject's skin S as illustrated with a dashed line for a given period of time is removed from the skin and attached to the gel container 42 of the cartridge 40. The cartridge 40 is loaded in the cartridge loading portion 22 of the biogenic substance measuring device 20, and the movable top plate 23 is then closed.

When the operation button 34 is pressed to start the measurement, air is blown into the tank 26 from the feeder 24, and the collecting liquid thereby flows from the tank 26 toward the nipple 24a. The collecting liquid is injected into the gel container 42 through the injection hole 42a to fill the gel container 42 with the collecting liquid. As a predetermined period of time thereafter passes, the tissue fluid collected in the extraction medium 12 diffuses in the collecting liquid. After the predetermined period of time passed, the feeder 24 blows air into the gel container 42 through a bypass channel 24b. As a result, the liquid in the gel container 42 is transported through the flow channel 43a into the first reservoir 43 and the second reservoir 45.

The sodium ion detector 32 applies a certain voltage to the liquid reserved in the first reservoir 43 using the electrodes for measuring the sodium ion concentration to obtain a current value. The current value obtained then is in proportion to the sodium ion concentration in the liquid. The sodium ion detector 32 outputs the obtained current value to the controller 35 as a detection signal. The controller 35 obtains the sodium ion concentration C_{Na} based on the current value included in the detection signal and an analytical curve previously stored in the storage unit of the controller 35.

In the second reservoir, the glucose reactor 41 and the glucose in the collecting liquid react with each other, and the glucose reactor 41 accordingly changes in color. The glucose detector 31 irradiates the light from the light source 31a toward the optical waveguide member 44, and receives the light outgoing from the optical waveguide member 44 using the photo detector 31b. When the light emitted from the light source 31a is irradiated, the light is repeatedly reflected in the optical waveguide member 44 while being absorbed by the color-changed glucose reactor 41, and then penetrates through the photo detector 31b. A quantity of the light received by the photo detector 31b is in proportion to a degree of color change of the glucose reactor 41, and the degree of color change is in proportion to a quantity of glucose in the collecting liquid. The glucose detector 31 outputs the obtained quantity of received light to the controller 35 as a detection signal. The controller 35 obtains the glucose concentration C_{Glu} based on the quantity of received light included in the detection signal and an analytical curve previously stored in the storage unit of the controller 35.

When the sodium ion concentration C_{Na} and the glucose concentration C_{Glu} are obtained, more air is blown into the cartridge 40 from the feeder 24. Accordingly, the collecting liquid is finally transported to the waste liquid tank 25 through the discharge hole 45a and the nipple 25a. Then, a sequence of measuring steps ends.

Fine Pore Forming Device

A fine pore forming device (puncturing tool) configured to form fine pores in a test subject's skin is hereinafter described. The fine pore forming device is configured to form a large number of fine pores in a part of a test subject's skin to accelerate the extraction of tissue fluid from the test subject's skin. According to the present embodiment, glucose and sodium ions are collected from a test subject's skin S where fine pores are formed to accelerate the extraction of tissue fluid (see FIG. 1).

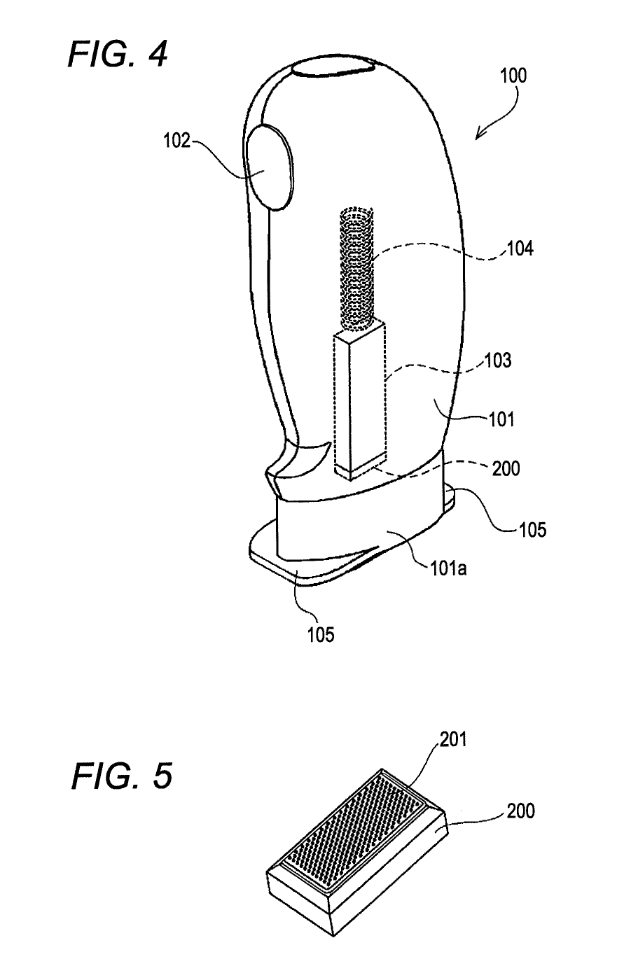

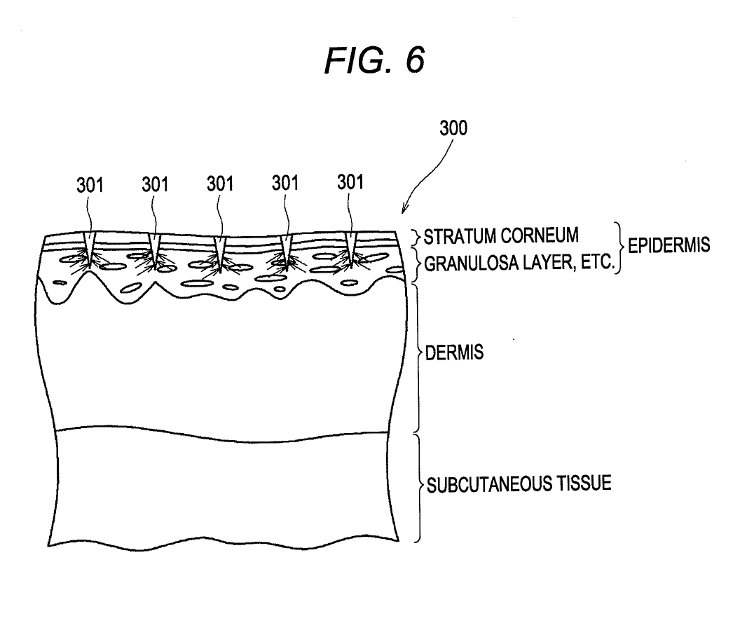

FIG. 4 is a perspective illustration of a puncturing tool 100, which is an example of the fine pore forming device, used in the biogenic substance measuring method according to the present invention to form fine pores in a test subject's skin to accelerate the extraction of tissue fluid. FIG. 5 is a perspective view of a fine needle chip 200 loaded in the puncturing tool 100 illustrated in FIG. 4. FIG. 6 is an illustration of the skin S in cross section where fine pores are formed by the puncturing tool 100.

As illustrated in FIGS. 4 to 6, the puncturing tool 100 is loaded with the sterilized fine needle chip 200, and when fine needles 201 of the fine needle chip 200 are pushed against the epidermis of a test subject's skin (test subject's skin 300), pores are formed in the test subject's skin 300 to extract tissue fluid therethrough (fine pores 301). The fine needles 201 of the fine needle chip 200 are dimensionally small enough for the fine pores 301 formed by the puncturing tool 100 to stay in the epidermis of the skin 300 without penetrating therethrough to reach the dermis therebelow.

The fine needle 201 has a truncated conical shape in a microscopic view, wherein a length dimension and a tip diameter are suitably set in consideration of a film thickness provided on the test subject's skin. Though not necessarily limited to the present invention, the fine needle 201 normally has a length dimension from about 100 μm to 1,000 μm, and a tip diameter from about 1 μm to 50 μm.

As illustrated in FIG. 4, the puncturing tool 100 includes a cabinet 101, a release button 102 provided on a surface of the cabinet 101, an array chuck 103 provided inside the cabinet 101, and a spring member 104. An opening which allows the fine needle chip 200 to pass therethrough (not illustrated in the drawing) is formed in a lower end surface (surface in contact with the skin) in a lower section 101a of the cabinet 101. The spring member 104 exerts a function of energizing the array chuck 103 in a puncturing direction. The array chuck 103 is structurally configured to mount the fine needle chip 200 on a lower end thereof. A plurality of fine needles 201 are provided on a lower surface of the fine needle chip 200. The lower surface of the fine needle chip 200 has the size of 10 mm (longer side)×5 mm (shorter side). The puncturing tool 100 has a securing mechanism (not illustrated in the drawing) which securely holds the array chuck 103 being pushed upward (opposite to the puncturing direction) against the energizing force of the spring member 104. When a user (test subject) presses the release button 102, the array chuck 103 secured by the securing mechanism is released. Then, the array chuck 103 is moved in the puncturing direction by the energizing force of the spring member 104, and the fine needles 201 of the fine needle chip 200 protruding through the opening are punctured into the skin. Referring to FIG. 4, a flange portion 105 is formed in the lower section 101a of the cabinet 101. When the puncturing tool 100 is used, a rear surface of the flange portion 105 is pushed against a predefined site of the test subject's skin.

Collecting Member

Next, the collecting member 10 used to collect tissue fluid from a test subject's skin is described. The collecting member 10 is attached to a test subject's skin to collect tissue fluid from the skin and removed from the skin after a predetermined period of time passed.

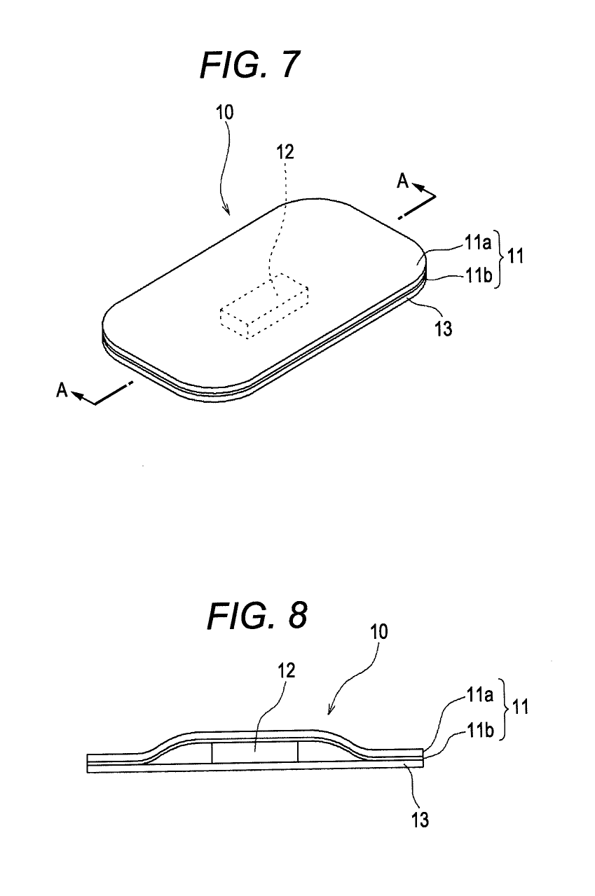

FIG. 7 is a perspective illustration of a collecting member 10 including a retaining sheet 11 and an extraction medium 12 retained in the retaining sheet 11. FIG. 8 is a sectional view cut along A-A line illustrated in FIG. 7.

The extraction medium 12 is made of a water-retainable gel that can retain tissue fluid extracted from the test subject's skin and contains an osmotic pressure regulator including no sodium ions. Though the gel is not particularly limited as far as tissue fluid can be thereby collected, a gel obtained from at least one hydrophilic polymer selected from a group consisting of polyvinyl alcohol and polyvinyl pyrolidone is preferably used. The hydrophilic polymer used to form the gel may be produced from polyvinyl alcohol alone or polyvinyl pyrolidone alone or may be produced from a mixture of these materials. More desirably, polyvinyl alcohol alone or a mixture of polyvinyl pyrolidone and polyvinyl alcohol is used as the hydrophilic polymer.

The gel can be formed by cross-linking the hydrophilic polymer in a water solution. For example, a water solution containing the hydrophilic polymer is applied to a medium to form a film, and the hydrophilic polymer included in the film is cross-linked to form the gel. Examples of the crosslinking method are chemical crosslinking and radiation crosslinking. Of these examples, radiation crosslinking is preferably adopted because it largely reduces the likelihood that the gel is contaminated with chemical materials as impurities.

In the illustrations of FIGS. 7 and 8, the extraction medium 12 has a parallelepipedal shape, and its surface in contact with the skin has the size of 5 mm×10 mm. The shape and the size of the extraction medium 12 are not necessarily limited to the given examples.

The retaining sheet 11 includes a sheet body 11a having an oval shape and an adhesive layer 11b formed on a surface of the sheet body 11a. The surface where the adhesive layer 11b is formed serves as an adhesive surface. The extraction medium 12 is provided at a substantially central part of a peel-off sheet 13 similarly having an oval shape and functioning as a mount. The retaining sheet 11 is adhered to the peel-off sheet 13 so as to coat the extraction medium 12. The extraction medium 12 is retained in the retaining sheet 11 by a part of the adhesive surface of the retaining sheet 11. The retaining sheet 11 has an area dimension large enough to coat the extraction medium 12 so that the extraction medium 12 is not dried during the collection of tissue fluid. When the extraction medium 12 is thus coated with the retaining sheet 11, the skin and the retaining sheet 11 airtightly contact each other, thereby avoiding evaporation of a water content of the extraction medium 12 during the collection of tissue fluid.

The sheet body 11a of the retaining sheet 11 is a colorless transparent material or a colored transparent material, so that the collecting member 12 retained in the retaining sheet 11 can be easily visually confirmed from a surface side of the sheet body 11a (surface opposite to the adhesive layer 11b). The sheet body 11a preferably has a low moisture permeability to avoid evaporation of tissue fluid and drying of the collecting member. Exemplified materials of the sheet body 11a are; polyethylene film, polypropylene film, polyester film, and polyurethane film. Of these examples, polyethylene film or polyester film is preferably used. Though not specifically defined, the sheet body 11a has a thickness dimension from about 0.025 mm to 0.5 mm.

The collecting member 10 is attached to the test subject's skin 300 with the adhesive surface of the retaining sheet 11 so that the extraction medium 12 is located in a part of the skin where fine pores are formed. The collecting member 10 is left on the skin with the extraction medium 12 being located in the part where fine pores are formed over a predetermined period of time, for example, at least 60 minutes or preferably at least 120 minutes. Then, the constituent of tissue fluid extracted through the fine pores is collected in the extraction medium 12.

Biogenic Substance Measuring Method

Next, the biogenic substance measuring method according to the present embodiment is described in detail below.

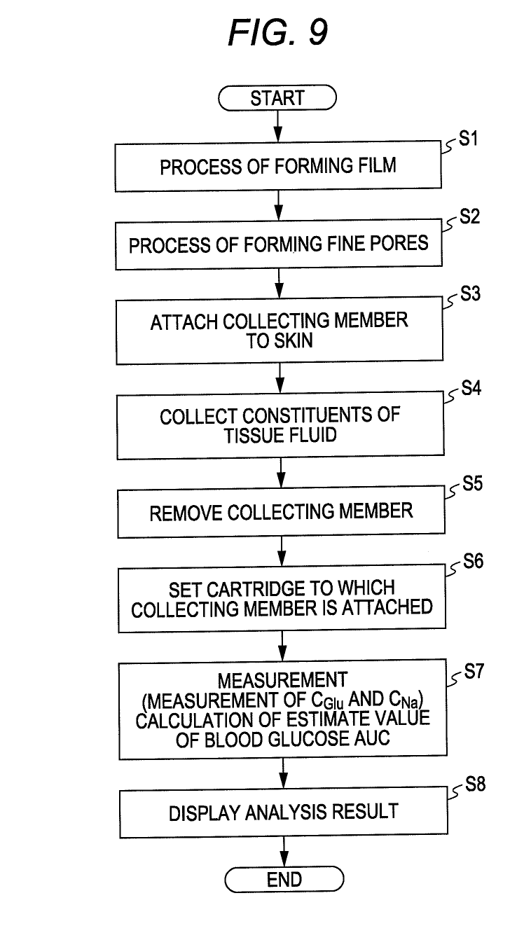

FIG. 9 is a flow chart of the biogenic substance measuring method according to the embodiment.

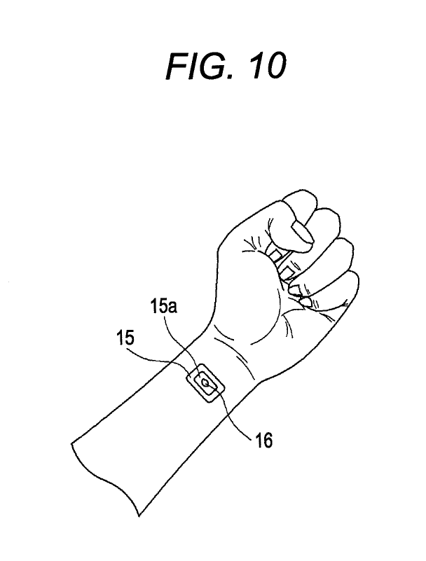

In Step S1, a water-impermeable film is formed in a part of the test subject's skin where fine pores will be formed. More specifically describing the step, the subject's skin 300 is cleaned with alcohol to remove any disturbing elements possibly affecting a measurement result (for example, dust). Next, a frame-shape seal 15 is attached to the cleaned part as illustrated in FIG. 10. The frame-shape seal 15 is formed in a rectangular shape and has an opening 15a which defines an area of the skin to be applied with a film-forming resin, described later, in a central part thereof. The frame-shape seal 15 has a thickness dimension larger than an intended film thickness.

Then, the opening 15a of the frame-shape 15 is filled with a film-forming resin 16 in liquid phase, and the resin is flattened with a tool not illustrated in the drawing such as a trowel, so that the resin spreads in a uniform thickness in the whole opening 15a. Any surplus resin is removed from the opening by the trowel. When the resin thus spread in the opening is dried over a predetermined period of time (for example, above five minutes), a film is formed.

Water-Impermeable film

The water-impermeable film according to the present embodiment is described in detail.

The water-impermeable film according to the present embodiment can be obtained by spreading and drying the film-forming resin in liquid phase on the test subject's skin. The film-forming resin in liquid phase can be obtained by dissolving a film-forming resin in a solvent.

The film-forming resin is preferably water-impermeable to prevent infiltration of perspiration (prevent infiltration of inorganic ions in perspiration) and further prevent dissolution of the resin in the tissue fluid extraction medium. The film-forming resin preferably further has the following properties 1) to 3).

1) To make the formed film penetrate into wrinkles of the test subject's skin for a better adhesiveness to the skin so that the extracted tissue fluid is not contaminated with perspiration, the resin is in liquid phase when applied to the skin surface and dries quickly once applied.
2) The film, if having high stretch properties, may deform in response to the shapes of fine needles during the punching by the puncturing tool, making it difficult for the fine needles to penetrate therethrough. Therefore, the film needs to have an enough rigidity in dry condition for the fine pores to be formed through the film.
3) The film provided to coat the skin surface of a human body should meet the safety requirements for living body.

Examples of synthetic resins meeting having such properties are: cellulose-series resins such as nitrocellulose; acrylic resins such as acrylic acid—styrene copolymer, acrylic acid—methacrylic acid amide copolymer, butyl acrylate—methacrylic acid copolymer, hydroxypropyl acrylate-butyl aminoethyl methacrylate octylamide acrylate copolymer, acrylamide—polyvinylalcohol copolymer, dimethylaminoethyl methacrylate—ester methacrylate copolymer, and ethyl acrylate—methyl methacrylate-trimethylammoniumethyl methacrylate chloride copolymer; vinyl-series resins such as polyvinylalcohol, polyvinylpyrolidone, and ethylene—vinyl acetate copolymer; epoxy-series resins; urethane-series resins; silicone-series resins; fluorine-series resins; and alkyd-series resins. Of these synthetic resins, preferable examples are cellulose-series resins and acrylic resins meeting the high human safety standards. A particularly preferable example is pyroxene which is nitrocellulose acetoacetic-esterified at two positions per glucose unit.

Examples of the solvent in which the synthetic resins can be dissolved are: alcohol-series solvents such as ethanol, isopropanol, and methyl isobutyl isopropanol; ketone-series solvents such as acetone, methylethyl ketone and methyl isobutyl ketone; ester-series solvents such as acetic ester, butyl acetate, adipic acid diisopropyl, sebacic acid diisopropyl, and triacetin; and aromatic-series compounds such as xylene and toluene.

The pyroxene dissolved in an ethanol—ether mixed solution is called collodion. The collodion can be suitably used as the film-forming resin in liquid phase.

The film according to the present invention is not particularly limited but may have an arbitrary thickness dimension in terms of its material, desirable strength, and formability of fine pores. A numeral range of the thickness dimension is, for example, from 5 μm to 1,000 μm. The numeral range is preferably from 10 μm to 300 μm, and more desirably from 20 μm to 100 μm. Though a relationship between the fine needle length and the film thickness differs depending on the materials of the fine needles and the film, the fine needles normally have a length dimension about 1 to 100 times as large as the film thickness.

Back to FIG. 9, in Step S2, the fine pores are formed in the test subject's skin. More specifically describing the step, the flange portion 105 of the puncturing tool 100 loaded with the fine needle chip 200 is located on the frame-shape seal 15 where the film is formed in the opening 15a in Step S1 so that the fine needle chip 200 makes contact with the film. Then, the release button 102 is pressed to make the fine needles 201 of the fine needle chip 200 penetrate through the film to contact the test subject's skin 300, so that the fine pores 301 are formed in the skin 300. The formation of the fine pores 301 can accelerate the extraction of tissue fluid from the skin 300.

In Step S3, the puncturing tool 100 is removed from the test subject's skin 300, and the retaining sheet 11 of the collecting member 10 is attached to the test subject's skin 300 so that the extraction medium 12 is located in an area of the skin where the fine pores 301 are formed (fine pore formation area) (see FIG. 1).

In Step S4, tissue fluid is extracted from the test subject's skin and collected in the collecting member 10, and glucose and sodium ions included in the tissue fluid are collected and stored in the extraction medium 12 of the collecting member 10. A length of time for collecting the tissue fluid is from about 60 minutes to 180 minutes. The test subject may undergo perspiration during the collection of tissue fluid. However, the perspiration does not penetrate through the film or infiltrate the extraction medium 12 because the film formed in the fine pore formation area is water-impermeable. Thus technically configured, the perspiration from the skin during the measuring operation does not adversely affect any measured values.

In Step S5, the collecting member 10 is removed from the test subject's skin.

In Step S6, the collecting member 10 is attached to the cartridge 40 at a predefined position thereof, and the cartridge 40 is loaded in the cartridge loading portion 22 of the biogenic substance measuring device 20.

In Step S7, the measuring steps are performed by the biogenic substance measuring device 20, and the glucose concentration C_{Glu} and the sodium ion concentration C_{Na} in the extraction medium 12 are calculated from the measured values obtained in the measuring steps. Next, the controller 35 calculates the blood glucose AUC based on the glucose concentration C_{Glu} and the sodium ion concentration C_{Na} and the following numerical expression 1).

AUC=C_{Glu}×V/{αC_{Na}×V/t)+β} 1)

In the numerical expression 1), V represents the volume of the extraction medium 12 of the collecting member 10, and t represents an extraction time. α and β are constants calculated through a test. U.S. Patent Publication No. 2011/124998 provides a detailed description of a calculation principle wherein the blood glucose AUC is calculated based on the numerical expression 1). The contents of U.S. Patent Publication No. 2011/124998 are incorporated herein by reference.

In Step S8, the controller 35 outputs a calculation result thereby obtained to the display unit 33.

Verification of Effect

Below is given a description to an improvement of the measurement accuracy achieved by the biogenic substance measuring method according to the present invention.

### Reference Example

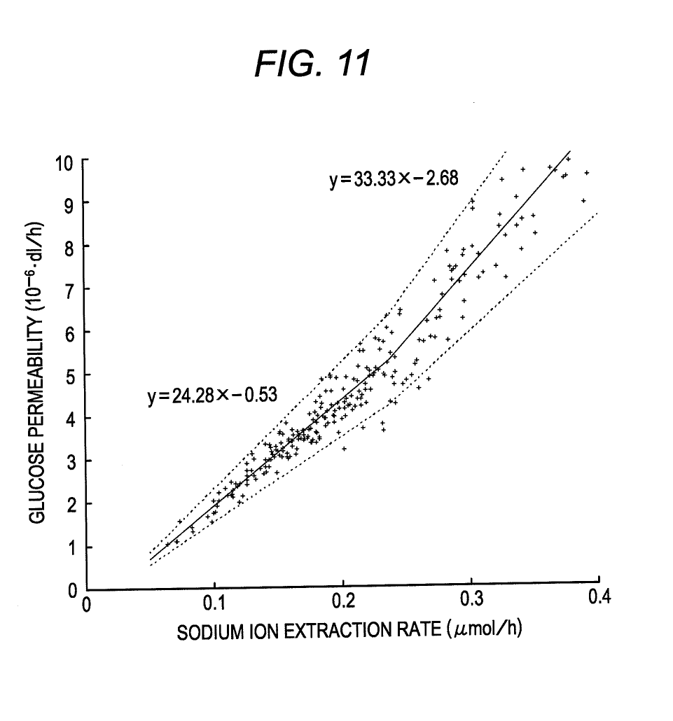

In an environment where perspiration is assumed to exert no influences or less influences (environmental load: 25° C., measuring time: 2 hours), a test for extracting tissue fluid from a test subject's skin where the film according to the present invention is not formed was performed under the following conditions to study a correlation between a glucose permeability (P_{Glu}) and a sodium ion extraction rate (J_{Na}). FIG. 11 shows a test result. In the reference example, a gel patch was attached for two hours to a part of the skin where fine pores were formed to store tissue fluid in the gel patch. The glucose permeability (P_{Glu}) can be calculated from extracted glucose quantity/blood glucose AUC. The sodium ion extraction rate (J_{Na}) can be calculated from; extracted sodium ion concentration×purified water quantity (L)/extraction time (h).

Test Conditions

number of analytes (test subjects): 264 analytes (20 test subjects)

tissue fluid extraction medium: gel patch (see collecting member illustrated in FIGS. 7 and 8)

extraction area dimension: 5 mm×10 mm

extraction time: 2 hours

glucose concentration measuring method: GOD fluorescence absorption spectroscopy

sodium ion concentration measuring method: ion chromatography

shape of fine needle array: fine needle length=300 μm, number of fine needles=305

puncturing rate: 6 m/s

blood glucose measuring method: self-monitoring of blood glucose (SMBG) performed on forearm capillary at the intervals of 15 minutes when blood glucose is changing, forearm SMBG values measured at the intervals of at least 30 minutes when blood glucose was stable

blood glucose AUC reference value measuring method: calculated by trapezoidal approximation from forearm SMBG values

Measuring Steps:

### Step 1 (Skin Pre-Treatment, Tissue Fluid Extraction, and Blood Glucose Measurement)

The back side of the test subject's forearm was disinfected with ethanol-impregnated cotton, and the fine needle array loaded in a dedicated puncturing tool was applied to the skin surface. Then, the gel patch was attached to a part of the skin where fine pores were formed for two hours to store tissue fluid in the gel patch. The self-monitoring of blood glucose (SMBG) was performed on forearm capillary at the intervals of 15 minutes when blood glucose is changing after meal, and forearm SMBG values were measured at the intervals of at least 30 minutes when blood glucose was stable in at least three hours after meal.

Step 2 (Sample Measurement)

When two hours passed after the gel patch was attached to the skin, the hydrogel alone was peeled off from the collected gel patch and dipped in 5 mL of purified water and stored overnight in a refrigerator set to the temperature of 4° C. Then, biogenic substances stored in the hydrogel were collected. Then, the glucose concentration was measured in all of the samples undiluted, while the sodium ion concentration was measured in the samples diluted by five times.

Step 3 (Result Analysis)

The samples of the extracted tissue fluid were analyzed, and the glucose permeability (P_{Glu}) and the sodium ion extraction rate (J_{Na}) were calculated from an obtained analysis result based on the following numerical expressions 2) and 3). M_{Glu} and M_{Na} in the numerical expressions respectively represent a total volume of glucose and a total volume of sodium ions. AUC represents a value of the blood glucose AUC calculated from the blood glucose level. T represents the extraction time. The glucose permeability represents a value largely reflecting a fine pore formability. The sodium ion concentration in the tissue fluid of a living body is almost equal among a plurality of test subjects who respectively have different blood glucose levels. Therefore, there is probably a favorable correlation between the glucose permeability and the sodium ion extraction rate. A regression line is bent at an intermediate point, J_{Na}=0.24. The regression line Of 0.24 is expressed by y=24.28x−0.53, and the regression line of J_{Na}>is expressed by y=33.33x−2.68.

$$\begin{matrix}Numerical Expression 1 & \\ {P}_{Glu} ( \times {10}^{- 6} dl / h ) = \frac{{M}_{Glu} ( ng )}{AUC ( mg \cdot h / dl )} & ( 2 ) \\ {J}_{Na} ( μ mol / h ) = \frac{{M}_{Na} ( μ mol )}{T ( h )} & ( 3 )\end{matrix}$$

FIG. 11 is a graphical illustration of a correlation between the glucose permeability and the sodium ion extraction rate calculated from the measurement result. Referring to FIG. 11, a solid line represents the regression line, and dotted lines represent ±20% from the regression line. It is known from FIG. 11 that the glucose permeability (P_{Glu}) and the sodium ion extraction rate (J_{Na}) obtained when the tissue fluid is extracted through the fine pores strongly correlate with each other. Therefore, when the regression line is used to estimate the glucose permeability from the sodium ion extraction rate (J_{Na}), a quantity of tissue fluid to be extracted is corrected, and the blood glucose AUC value can be accordingly calculated. In the case where the extraction medium is contaminated with glucose and sodium ions originated from perspiration during the measurement, an obtained result largely deviates to right from the regression line because of a large quantity of sodium ions included in perspiration as compared to glucose. This possibly deteriorates an accuracy in estimating the blood glucose AUC value.

### Working and Comparative Examples

Tests were performed to verify a perspiration inhibiting effect exerted by the film according to the present invention. The details of the test are described below.

Test Conditions

number of test subjects: 1 test subject

film-forming material :EKIVAN A (product name, a liquid-type adhesive plaster bandage produced by Taihei Yakuhin Co., Ltd.)

spacer thickness (frame-shape seal): about 165 μm

drying time: about 10 minutes

punctured sites: 10 sites (including six film formation sites)

sites not punctured: 0.2 sites (including one film formation site)

shape of fine needle array: tip diameter=about 10 μm, length of fine needles=300 μm, number of fine needles=189,305

puncturing rate: 6, 8.5, 10 m/s

tissue fluid extraction medium: gel patch (see collecting member illustrated in FIGS. 7 and 8)

extraction area dimension: 5 mm×10 mm

extraction time: 2 hours

temperature load: 40° C., 30 minutes

glucose concentration measuring method: GOD fluorescence absorption spectroscopy

sodium ion concentration measuring method: ion chromatography

blood glucose measurement: a blood glucose self-monitoring device used for measurement at the intervals of at least 30 minutes (all of the tests performed when blood glucose was stable)

blood glucose AUC reference value measuring method: calculated by trapezoidal approximation from forearm SMBG values

Measuring Steps:

Step 1 (Film Formation)

The back side of the test subject's forearm was disinfected with ethanol-impregnated cotton, and a spacer having a rectangular shape and a thickness dimension of about 165 μm was attached thereto. The spacer is a seal member having a frame shape. The spacer has an opening in the size of 8 mm×13 mm in a central part thereof, to which the film-forming material is applied. After an adequate quantity of EKIVAN A was dropped in the opening of the spacer, any surplus EKIVAN A higher than the thickness of the spacer was removed with a metal trowel and dried for 10 minutes to form a water-impermeable film. This formation technique succeeded in the formation of an almost uniform film in the area of 8 mm×13 mm. The film thus formed on a glass slide by this technique had a film thickness in the range of 20.6±3.4 μm.

Step 2 (Skin Pre-Treatment, Tissue Fluid Extraction, and Blood Glucose Measurement)

The fine needle array loaded in a dedicated puncturing tool was applied to six film formation sites and four no-film sites, ten sites in total. Then, the gel patch was attached to a part of the skin where fine pores were formed for two hours to store tissue fluid in the gel patch. At the same time, the gel patch was attached for two hours to one film formation site and one no-film site, two sites in total. These sites were not subject to the application of the fine needle array. Then, the test subject was placed under the temperature load of 40° C., 30 minutes to stimulate perspiration during the 2-hour extraction of tissue fluid. Further, blood was collected from the forearm capillary at the intervals of 30 minutes to measure the blood glucose level using a blood glucose self-monitoring device (SMBG) during the 2-hour extraction of tissue fluid.

Step 3 (Sample Measurement)

When two hours passed after the gel patch was attached to the skin, the hydrogel alone was peeled off from the collected gel patch and dipped in 5 mL of purified water and stored overnight in a refrigerator set to the temperature of 4° C. Then, the biogenic substances stored in the hydrogel were collected. Then, the glucose concentration was measured in all of the samples undiluted. To measure the sodium ion concentration in the samples, the samples to which the fine needle array was applied were diluted by five times, while the samples to which the fine needle array was not applied were undiluted.

Step 4 (Result Analysis)

The samples of the extracted tissue fluid were analyzed, and the glucose permeability (P_{Glu}) and the sodium ion extraction rate (J_{Na}) were calculated from an obtained analysis result based on the following numerical expressions 2) and 3).

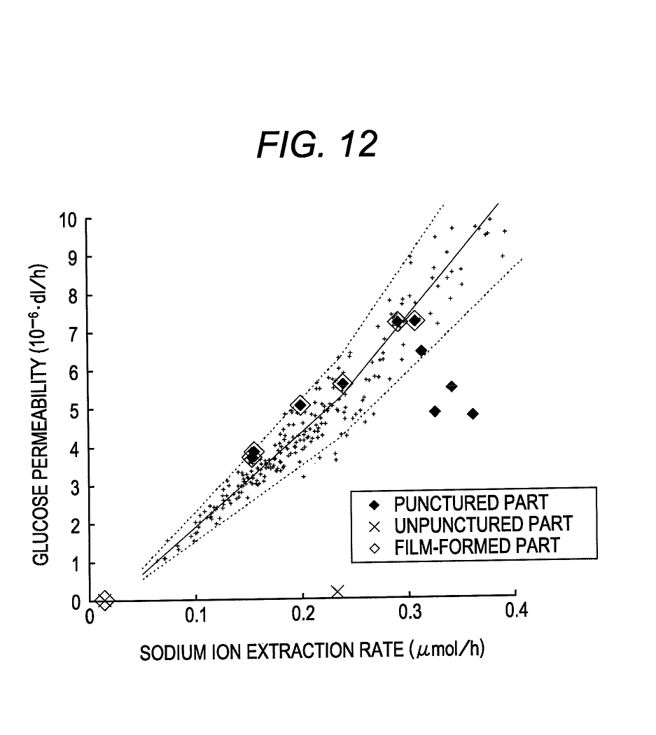

FIG. 12 is a graphical illustration of results obtained from the working example (punctured after the film Was formed) and the comparative example (punctured in the absence of the film). FIG. 12 shows the obtained result superimposed on the illustration of FIG. 11.

Referring to the result of the unpunctured sites illustrated with x in FIG. 12, the sodium ion extraction rate was at least 0.2 μmol/h in the sites where the film was not formed but was almost 0 in the sites where the film was formed. This indicates that the hydrogel was not contaminated with sodium ions from perspiration in the sites where the film was formed.

A similar tendency was confirmed in the punctured sites. In the sites where the film was not formed (comparative example), the hydrogel was contaminated with sodium ions secreted from perspiration glands as a result of perspiration, and three of the four sites resulted in large deviations to right from the ±20% error range of the regression line. On the contrary, all of the six sites where the film was formed (working example) stayed within the ±20% error range of the regression line. An average ratio of measured value deviation was 1.03±0.03 in the working example but was 0.69±0.13 in the comparative example. The ratio of measured value deviation is a value obtained by dividing the estimated blood glucose AUC by the collected blood glucose AUC. As the ratio of measured value deviation is more approximate to 1, the estimated blood glucose AUC has a higher reliability.

In the event of perspiration during the extraction of tissue fluid, it leads to a poor measurement accuracy to correct the quantity of tissue fluid to be extracted based on the regression line of FIG. 11. According to the biogenic substance measuring method according to the present invention, wherein the film serves to control perspiration, the tissue fluid is not contaminated with sodium ions secreted from perspiration glands. As a result, the blood glucose AUC can be very accurately measured.

### Another Modified Embodiment

The present invention is not necessarily limited to the embodiment described so far, and may be variously modified within the technical scope defined by the Scope of Claims. According to the embodiment described so far; the film-forming resin in liquid phase is dropped on a test subject's skin to form the film and the dropped film-forming resin is flattened by a trowel. The film can be similarly formed when the film-forming resin in liquid phase is viscosity-controlled and sprayed on any predefined part of skin by means of any suitable sprayer and then dried. When the film is thus formed by spraying, the liquid film-forming resin may be directly sprayed on a test subject's skin, or an adapter having an opening corresponding to the shape of the film to be formed on a tip thereof may be mounted on a spray outlet of the sprayer and brought into contact with the skin to spray the resin through the opening of the adapter.

According to the embodiment described so far, the rectangular frame-shape seal having a rectangular opening corresponding to the shape of the fine needle chip (rectangular shape) is used. The opening shape and the outer shape of the frame-shape seal may be other shapes such as a circular shape or a polygonal shape.

What is claimed is:

1. A biogenic substance measuring method for measuring a constituent of tissue fluid extracted from a test subject's skin, comprising steps of:
forming a film having a water impermeability on the test subject's skin;
forming fine pores in the skin coated with the film so as to penetrate through the film;
extracting the tissue fluid from the test subject through the skin where the fine pores are formed and storing the constituent to be measured and inorganic ions of the extracted tissue fluid;
obtaining an ion information relating to a quantity of the stored inorganic ions;
obtaining a constituent information relating to a quantity of the stored constituent to be measured; and
obtaining an analysis value relating to the quantity of constituent to be measured based on the ion information and the constituent information.

2. The biogenic substance measuring method according to claim 1, wherein
a film-forming resin in liquid phase is applied to the test subject's skin and the applied film-forming resin is dried to form the film in the step of forming the film on the test subject's skin.

3. The biogenic substance measuring method according to claim 2, further comprising:
a step of attaching a frame-shape seal having an opening which defines an area where the film-forming resin is applied; wherein
the film-forming resin is applied to the opening of the frame-shape seal attached to the test subject's skin in the step of forming the film on the test subject's skin.

4. The biogenic substance measuring method according to claim 3, wherein
the frame-shape seal has a thickness dimension larger than a thickness of the film.

5. The biogenic substance measuring method according to claim 2, wherein
the film-forming resin is made of a cellulose-series resin or an acrylic resin.

6. The biogenic substance measuring method according to claim 5, wherein
the cellulose-series resin is pyroxylin.

7. The biogenic substance measuring method according to claim 2, wherein
the film-forming resin in liquid phase is obtained by dissolving a film-forming resin in an alcohol-series solvent, a ketone-series solvent, an ester-series solvent, or a solvent containing an aromatic compound.

8. The biogenic substance measuring method according to claim 1, wherein
the film has a film thickness dimension from 5 μm to 1,000 μm.

9. The biogenic substance measuring method according to claim 8, wherein
the film has a film thickness dimension from 10 μm to 300 μm.

10. The biogenic substance measuring method according to claim 9, wherein the film has a film thickness dimension from 20 μm to 100 μm.

11. The biogenic substance measuring method according to claim 1, wherein
fine needles of a fine needle chip mounted on an edge part of a puncturing tool are brought into contact with the test subject's skin through the film in the step of forming the fine pores.

12. The biogenic substance measuring method according to claim 11, wherein
the fine needles have a length dimension 1 to 100 times as large as the thickness dimension of the film.

13. The biogenic substance measuring method according to claim 11, wherein
the fine needles have a tip diameter from 1 μm to 50 μm.

14. The biogenic substance measuring method according to claim 1, wherein
the constituent to be measured is glucose.

15. The biogenic substance measuring method according to claim 1, wherein
the inorganic ions are sodium ions.

16. The biogenic substance measuring method according to claim 1, wherein
the constituent to be measured and the inorganic ions are extracted and collected in an extraction medium located on a surface of a retaining sheet adapted to be attached to the test subject's skin.

17. The biogenic substance measuring method according to claim 16, wherein
the extraction medium is made of a gel.

18. The biogenic substance measuring method according to claim 1, wherein
the ion information is a concentration of the inorganic ions.

19. The biogenic substance measuring method according to claim 1, wherein
an analysis value relating to a quantity of the constituent to be measured is a value representing an area under constituent to be measured-time curve.
